(19) United States
(12) Patent Application Publication
(10) Pub. No.: US 2009/0300373 A1
(43) Pub. Date: Dec. 3, 2009

(54) SYSTEM FOR TURNING A COMPUTER ON AND OFF

(75) Inventors: SHI-ZHEN CUI, Shenzhen City (CN); SONG GUO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/173,755

(22) Filed: Jul. 15, 2008

(30) Foreign Application Priority Data
May 30, 2008 (CN) 200810301850.X

(51) Int. Cl. G06F 1/26

(52) U.S. Cl. 713/300

(57) ABSTRACT

A system for turning a computer on and off, the system has a first switch mounted on an external device, and a control circuit for turning the computer on or off. The control circuit has a second switch and a first resistor. The first switch is connected between the second switch and a first power supply. The second switch is connected to a second power supply via the first resistor, and to a control end capable of turning the computer on or off. The first switch actuates the second switch. Upon a condition of the second switch turning on, the control end is grounded to turn the computer on or off.

### BACKGROUND

1. Field of the Invention

The present invention relates to a system for turning a computer on and off.

2. Description of Related Art

Generally, computers are turned on or off by pressing a button installed on a front panel of the computer. However, the computer front panel is usually put under a computer table, so users have to stoop or lean down to press the button to turn the computer on or off, which is inconvenient.

What is needed, therefore, is to provide a system for turning the computer on and off to make the operation convenient.

### BRIEF DESCRIPTION OF THE DRAWINGS

FIG. 1 is a perspective view of a keyboard in accordance with an embodiment of the present invention; and

FIG. 2 is a circuit diagram showing a system for turning a computer on and off in accordance with an embodiment of the present invention.

### DETAILED DESCRIPTION

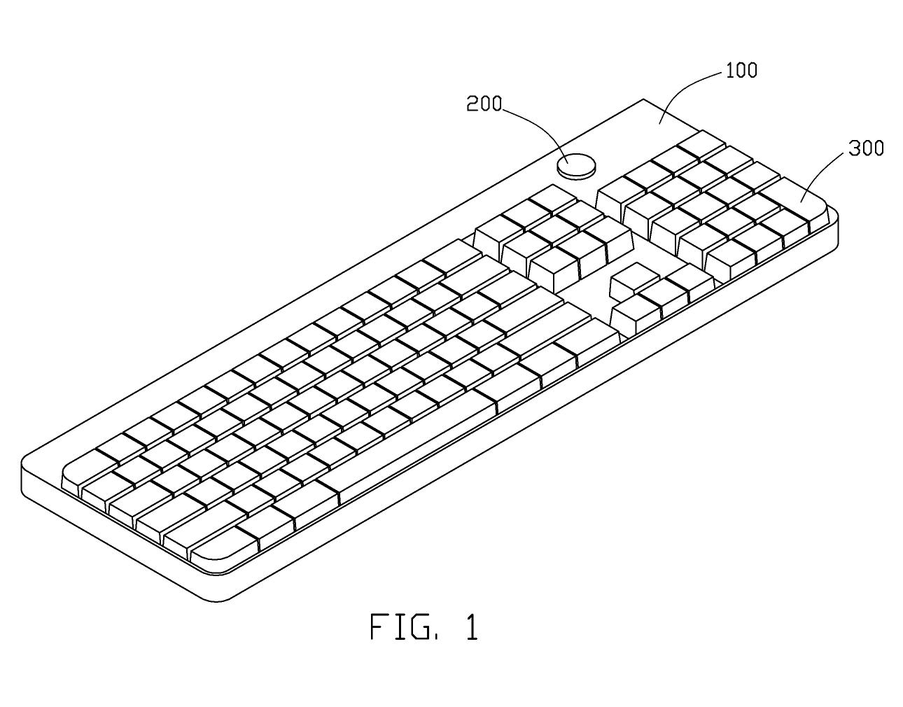

Referring to FIG. 1, a system for turning a computer on and off includes a keyboard, the keyboard includes a keyboard body 100, a plurality of keys 300, and a button 200. The keys 300 and the button 200 are arranged on an upper surface of the keyboard body 100. The button 200 is configured for turning the computer on or off.

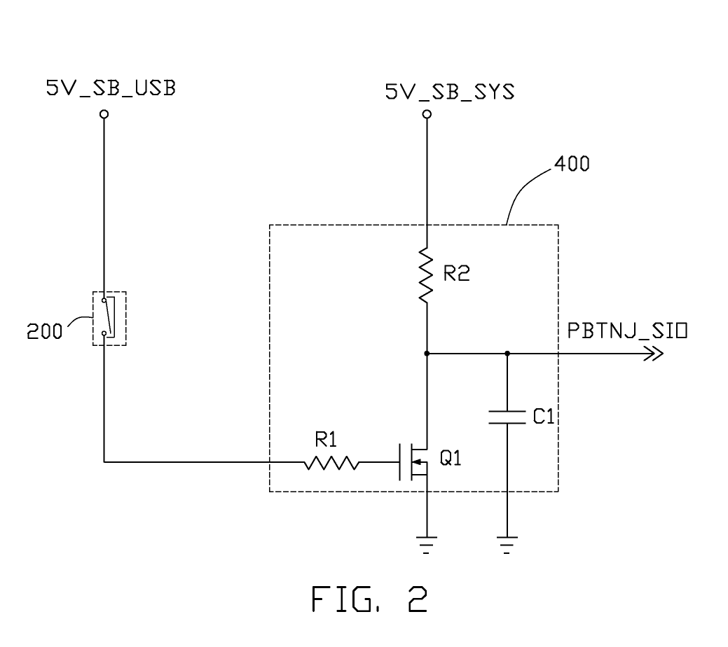

Referring to FIG. 2, the system further includes a control circuit 400 mounted on a motherboard of the computer. The circuit 400 includes two resistors R1, R2, a metal oxide semiconductor field-effect transistor (MOSFET) Q1 and a capacitor C1. The button 200 has a first pin connected to a 5V_SB_USB power supply, and a second pin connected to the MOSFET gate of the MOSFET Q1 via the resistor R1. The MOSFET drain of the MOSFET Q1 is connected to a 5V_SB_SYS power supply via the resistor R2, is grounded via the capacitor C1, and is also connected to a control end PBTNJ_SIO, the MOSFET source of the MOSFET Q1 is grounded. Wherein the button 200 is configured for turning the MOSFET Q1 on or off to send control signals to the control end PBTNJ_SIO. When the control end PBTNJ_SIO receives a low voltage and the computer is running this moment, the computer is turned off. When the control end PBTNJ_SIO receives a low voltage and the computer is powered off this moment, then the computer is turned on. When the control end PBTNJ_SIO receives a high voltage, the computer will maintain its current state.

When needs to turn on or off the computer, the button 200 is pressed down, the first pin and the second pin of the button 200 are connected to make the MOSFET gate of the MOSFET Q1 high level, the MOSFET Q1 turns on, and the control end PBTNJ_SIO is at low level. When the computer is running this moment, then the computer is turned off. When the computer is powered off this moment, then the computer is turned on.

When the button 200 is not pressed down, the first pin and the second pin of the button 200 are not connected, the MOSFET Q1 turns off, the control end PBTNJ_SIO is at high level, and it is not performed the operation of turning the computer on or off. It is understood that the system can cause the computer to immediately turn off or initiate a shut down sequence of the operating system.

In this embodiment, the MOSFET Q1 acting as a second switch is an N channel metal oxide semiconductor field-effect transistor (NMOSFET). In other embodiments, the button 200 acting as a first switch can be installed on a sidewall of the keyboard body 100 or installed on other external devices of the computer, such as a mouse. Thus, users can conveniently turn the computer on or off.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A system for turning a computer on and off, the system comprising:
a first switch mounted on an external device, and connected to a first power supply;
a control circuit comprising:
a first resistor connected to a second power supply; and
a second switch connected to the first switch, to the second power supply via the first resistor, and to a control end capable of turning computer on or off;
wherein the second switch is capable of moving between first and second positions; upon a condition of the second switch is moved to the second position and the computer is running, the control end is grounded to turn the computer off; upon a condition of the second switch is moved to the second position and the computer is powered off, the computer is turned on; upon a condition of the control end is at high level, the computer will maintain its current state; the second switch is actuated by the first switch.

2. The system as claimed in claim 1, wherein the first switch comprises a first pin connected to a first power supply, and a second pin connected to the second switch.

3. The system as claimed in claim 2, wherein the first switch comprises a button, the second switch is an N channel metal oxide semiconductor field-effect transistor (NMOSFET) comprising an NMOSFET gate, an NMOSFET source, and an NMOSFET drain; the NMOSFET gate is connected to the first power supply via the first switch; the NMOSFET drain is connected to the second power supply via the first resistor and is also connected to the control end; and the NMOSFET source is grounded.

4. The system as claimed in claim 3, wherein the control circuit further comprises a second resistor, the NMOSFET gate is connected to the first switch via the second resistor.

5. The system as claimed in claim 4, wherein the control circuit further comprises a capacitor, the capacitor is connected between the NMOSFET drain and a ground.

6. The system as claimed in claim 1, wherein the external device is a keyboard or a mouse.

7. The system as claimed in claim 1, wherein the control circuit is installed on a motherboard of the computer.

8. A method for turning a computer on and off, the method comprising of:
providing:
a first switch mounted on an external device, and connected to a first power supply;
a control circuit comprising:
a first resistor connected to a second power supply; and
a second switch connected to the first switch, to the second power supply via the first resistor, and to a control end turning the computer on or off;
the first switch actuates the second switch, the second switch moves between first and second positions;
turning off the computer by moving the second switch to the second position when the computer is running by grounding the control end; and
turning on the computer by moving the second switch to the second position when the computer is powered off.

9. The method as claimed in claim 8, wherein the first switch comprises a first pin connected to a first power supply, and a second pin connected to the second switch.

10. The method as claimed in claim 9, wherein the first switch is a button, the second switch is an N channel metal oxide semiconductor field-effect transistor (NMOSFET) comprising an NMOSFET gate, an NMOSFET source, and an NMOSFET drain; the NMOSFET gate is connected to the first power supply via the first switch; the NMOSFET drain is connected to the second power supply via the first resistor and is also connected to the control end; and the NMOSFET source is grounded.

11. The method as claimed in claim 10, wherein the control circuit further comprises a second resistor, the MOSFET gate is connected to the first switch via the second resistor.

12. The method as claimed in claim 11, wherein the control circuit further comprises a capacitor, the capacitor is connected between the NMOSFET drain and a ground.

13. The method as claimed in claim 8, wherein the external device is a keyboard or a mouse.

14. The method as claimed in claim 8, wherein the control circuit is installed on a motherboard of the computer.
